(19) United States
(12) Patent Application Publication
(10) Pub. No.: US 2024/0321097 A1
(43) Pub. Date: Sep. 26, 2024

(54) IOT NETWORK ENABLED REAL-TIME VIRTUALIZED TRAFFIC VIEWER

(71) Applicant: INTERNATIONAL BUSINESS MACHINES CORPORATION, ARMONK, NY (US)

(72) Inventors: Hamid Majdabadi, Ottawa (CA); Su Liu, Austin, TX (US); Guang Han Sui, Beijing (CN)

(21) Appl. No.: 18/189,314

(22) Filed: Mar. 24, 2023

(51) Int. Cl. G08G 1/137; G16Y 40/60

(52) U.S. Cl. CPC G08G 1/137; G16Y 40/60

(57) ABSTRACT

According to one embodiment, a method, computer system, and computer program product for generating a real-time virtualized traffic view is provided. The present invention may include receiving real-time traffic data from one or more selected live traffic status inputs; identifying one or more objects comprised within the real-time traffic data; determining one or more traffic characteristics of the identified objects; converting classified real-time traffic data to one or more virtualized live traffic images; stitching the one or more virtualized live traffic images together to create a virtualized live traffic stream; and rendering the virtualized live traffic stream on a client device.

### BACKGROUND

The present invention relates, generally, to the field of computing, and more particularly to digital mapping.

Digital mapping is a technological process by which data is compiled and formatted into a virtual image. Digital mapping is performed by comprising satellite imagery as well as street-level information. Currently, digital mapping can be used to create live traffic maps, thus, allowing a person to view current conditions in a geographic location, such as a certain highway for example. However, in order to maximize the potential benefits of using digital mapping, a method and system by which a real-time virtualized traffic view is provided are needed. Thus, an improvement in digital mapping has the potential to benefit drivers by increasing the accuracy, and thus the reliability, of digital mapping and optimizing travel time.

### SUMMARY

According to one embodiment, a method, computer system, and computer program product for generating a real-time virtualized traffic view is provided. The present invention may include receiving real-time traffic data from one or more selected live traffic status inputs; identifying one or more objects comprised within the real-time traffic data; determining one or more traffic characteristics of the identified objects; converting classified real-time traffic data to one or more virtualized live traffic images; stitching the one or more virtualized live traffic images together to create a virtualized live traffic stream; and rendering the virtualized live traffic stream on a client device.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an exemplary application invention environment according to at least one embodiment;

FIG. 3 is an operational flowchart illustrating a real-time virtualized traffic viewer process according to at least one embodiment;

FIG. 4 is a system diagram illustrating an exemplary program environment of an implementation of a real-time virtualized traffic viewer process according to at least one embodiment; and

FIG. 5 depicts a visual representation of an IoT data to live virtualized traffic map process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

In digital mapping, traffic data can be used to create a 2D (two-dimensional) map that displays traffic information. However, digital maps rely upon a vast amount of data being collected over time because the maps must be updated frequently, in order to provide persons with the most accurate reflection of a location. Additionally, a live stream of an area can be provided if one or more cameras are placed in the area. However, if no cameras are present in a location, a live stream of the location cannot be provided. Therefore, it may be likely that the optimization of digital mapping is limited because of the need to consistently collect, provide, and analyze traffic data, and the need for placing cameras in every location in which a live stream is sought.

One way in which current methods attempt to address problems with providing dynamically updated digital maps is by using devices such as sensors and/or cameras. The use of such devices allows for the identification of traffic congestion, by creating 2D digital maps which display road information and/or streaming a broadcast of a certain area, respectively. However, several deficiencies exist in the current method. One of the deficiencies of the current method is that one or more cameras must be physically present in an area in order to provide and support live traffic service in a specific area. Thus, if there is no camera present in a certain area, then no live traffic service can be provided. Another deficiency of the current method is that sensors cannot provide a video stream and only can provide traffic data which is used to generate a 2D digital map. Therefore, it would become necessary to place an abundance cameras of cameras and sensors in every area, in order to consistently provide a real-time traffic service. Thus, an improvement in digital mapping has the potential to improve the accuracy and reliability of digital mapping, thus, benefitting drivers and optimizing their travel time.

The present invention has the capacity to improve digital mapping by dynamically generating a real-time virtualized traffic view. The present invention can convert real-time traffic data received from an IoT network into images and stitch the images together to create a real-time traffic stream that can be rendered on a device. This improvement in digital mapping can be accomplished by implementing a system that receives real-time traffic data from one or more selected live traffic status inputs, identifies one or more objects comprised within the real-time traffic data, determines one or more traffic characteristics of the identified objects, converts classified real-time traffic data to one or more virtualized live traffic images, stitches the one or more virtualized live traffic images together to create a virtualized live traffic stream, and renders the virtualized live traffic stream on a client device.

In some embodiments of the invention, the real-time virtualized traffic viewer program, herein referred to as “the program”, the program can receive real-time traffic data from selected live traffic status inputs from the network. Live traffic status inputs can comprise a network of one or more IoT devices. A user may select an available live traffic status input from the client computing device and/or database for the program to analyze. A user may select live traffic status inputs on the graphical user interface (GUI) on the client computing device. The available live traffic status inputs may be viewed in a list or displayed on a 2D digital map in the geographical area, such as a road, highway, etc., in which they are located. Upon selection of a live traffic status input, the program can gather the real-time traffic data from the collection of one or more IoT device(s) in the selected live traffic status input.

The program can identify the objects comprised within the real-time traffic data. The program can identify objects, such as vehicles, within the real-time traffic data. The program can use object image recognition technology to identify the objects comprised within the live-traffic data. The program can determine traffic characteristics of the identified objects. The program can use fine-grained location-based services to collect the real-time traffic data comprising the relative positions of the identified vehicles, and to determine other traffic data such as how many lanes are on the road, a distance of objects from a certain vehicle, etc. Additionally, the program can classify the relative positions of the identified objects to one another, such as front-left, front, front-right, left, right, rear-leaf, and rear-right, based on the location(s) of the identified vehicles.

The program can convert the collected real-time traffic data to virtualized live traffic images, such as birds-eye view images. The program can convert the collected image(s) to aerial image(s) using inverse perspective mapping. The program can stitch the virtualized live traffic images together to create a virtualized live traffic stream. The program can stitch together multiple virtualized live traffic images, creating a larger image comprising a wider aerial view of the geographical area comprising the live traffic status input(s). The program can leverage image stitching methods to blend the virtualized live traffic images.

In some embodiments of the invention, the program may stitch virtualized live traffic images together with generated map images from communication interfaces within a vehicle that is not sharing movement characteristics such as position, speed, direction, etc. However, the program may estimate the vehicle's location through data provided from communication interfaces, such as a radio, from the vehicle to nearby identified vehicles. The program may estimate the location of the vehicle based on the vehicle's proximity to the nearby identified vehicles. The program may create a generated map image based on the determined location of the vehicle and may stitch the generated map image together with the virtualized live traffic images.

The program can render the virtualized live traffic stream on the client device. The virtualized traffic stream may be viewed on the GUI of the client computing device. The virtualized traffic stream may comprise a virtualized 2D map and/or live video. In some embodiments of the invention, the program may modify the virtualized live traffic stream. The program can modify the virtualized live traffic stream based on user preferences. User preferences may comprise objects that the user is interested in seeing in a virtualized live traffic stream, such as highlighting trucks on the road, only displaying vehicles that are not blue on the road, only displaying vehicles that are a certain color car on a highway, only displaying vehicles that are going at a certain speed on a highway, etc. The program may check the user's profile to check if a user has any preferences listed. If the user has preferences listed in their profile, the program can modify the virtualized live traffic stream by rendering highlighted and/or removing identified objects, etc., in the current frame of the virtualized live traffic stream on the client device.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to receive real-time traffic data from one or more selected live traffic status inputs, identify one or more objects comprised within the real-time traffic data, determine one or more traffic characteristics of the identified objects, convert classified real-time traffic data to one or more virtualized live traffic images, stitch the one or more virtualized live traffic images together to create a virtualized live traffic stream, and render the virtualized live traffic stream on a client device.

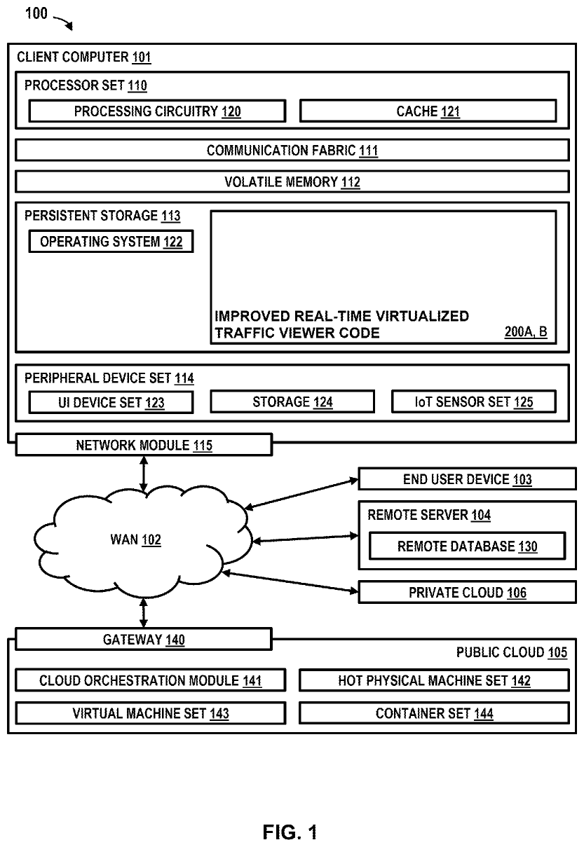

Referring to FIG. 1, an exemplary networked computer environment 100 is depicted, according to at least one embodiment. Computing environment 100 contains an example of an environment for the execution of at least some of the computer code involved in performing the inventive methods, such as improved real-time virtualized traffic viewer code 200A, 200B. In addition to code block 200A, 200B, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 200A, 200B, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 200A, 200B in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 200A, 200B typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

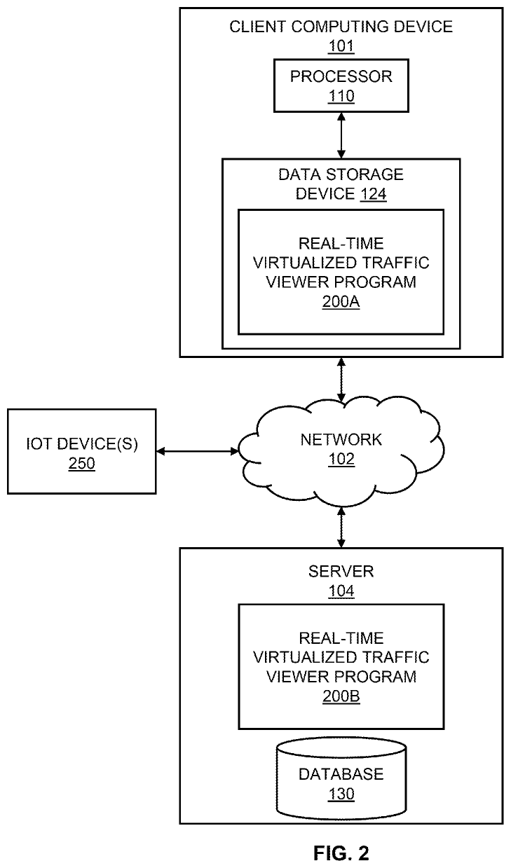

Referring to FIG. 2, an exemplary application environment is depicted, according to at least one embodiment. FIG. 2 may include client computing device 101 and a remote server 104 interconnected via a communication network 102. According to at least one implementation, FIG. 2 may include a plurality of client computing devices 101 and remote servers 104, of which only one of each is shown for illustrative brevity. It may be appreciated that FIG. 2 provides only an illustration of one implementation and does not imply any limitations with regard to the environments in which different embodiments may be implemented. Many modifications to the depicted environments may be made based on design and implementation requirements.

Client computing device 101 may include a processor 110 and a data storage device 124 that is enabled to host and run a real-time virtualized traffic viewer program 200A and communicate with the remote server 104 via the communication network 102, in accordance with one embodiment of the invention.

The remote server computer 104 may be a laptop computer, netbook computer, personal computer (PC), a desktop computer, or any programmable electronic device or any network of programmable electronic devices capable of hosting and running a real-time virtualized traffic viewer program 200B and a database 130 and communicating with the client computing device 101 via the communication network 102, in accordance with embodiments of the invention. The remote server 104 may also operate in a cloud computing service model, such as Software as a Service (SaaS), Platform as a Service (PaaS), or Infrastructure as a Service (IaaS). The remote server 104 may also be located in a cloud computing deployment model, such as a private cloud, community cloud, public cloud, or hybrid cloud.

The database 130 may be a digital repository capable of data storage and data retrieval. The database 130 can be present in the remote server 104 and/or any other location in the network 102. The database 130 can comprise real-time traffic data. Additionally, the database 130 can comprise user profiles.

IoT device(s) 250 may be located on/in the exterior and interior of a vehicle, such as a sedan or truck, among other locations. IoT device(s) 250 can comprise cameras, such as any device capable of recording visual images in the form of photographs, films, or video signals, such as a physical or virtual camera, and/or sensors, such as radars, accelerometers, gyroscopes, magnetometers, proximity sensors, pressure sensors, etc. Additionally, IoT device(s) 250 can comprise any type of communication interfaces 250 within a vehicle, such as WLAN interfaces, cellular data radios, Bluetooth® modules, speakers, NFC devices, and dedicated short-range communications. The IoT device(s) 250 can be connected to the network 102.

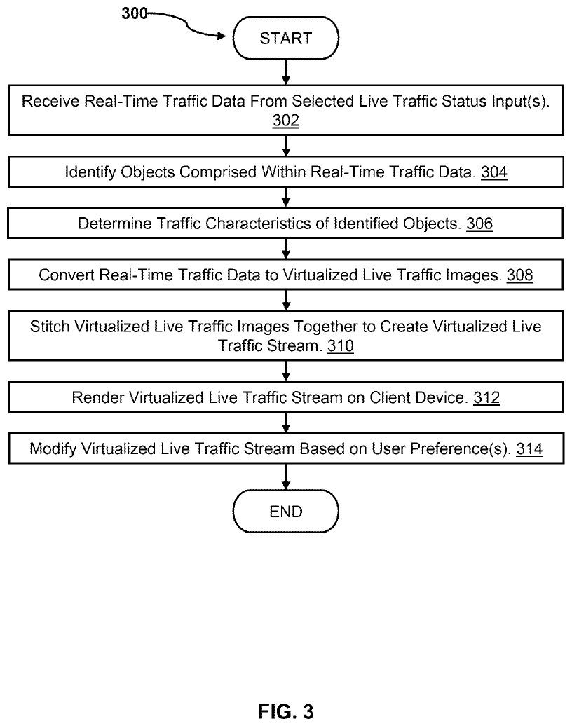

According to the present embodiment, the real-time virtualized traffic viewer (RVTV) program 200A, 200B, herein referred to as “the program”, may be a program capable of receiving real-time traffic data from selected live traffic status input(s), identifying objects comprised within the real-time traffic data, determining traffic characteristics of identified objects, converting classified real-time traffic data to virtualized live traffic images, stitching virtualized live traffic images together to create virtualized live traffic stream, rendering virtualized live traffic stream on a client device, and modifying virtualized live traffic stream based on user preference(s). The program 200A, 200B may be located on client computing device 101 or remote server 104 or on any other device located within network 102. Furthermore, the program 200A, 200B may be distributed in its operation over multiple devices, such as client computing device 101 and remote server 104. The real-time virtualized traffic viewer method is explained in further detail below with respect to FIG. 3.

Referring now to FIG. 3, an operational flowchart illustrating a real-time virtualized traffic viewer (RVTV) process 300 is depicted according to at least one embodiment. At 302, the program 200A, 200B receives real-time traffic data from selected live traffic status inputs from the network 102. Live traffic status inputs can comprise a network of one or more IoT device(s) 250. A user may select an available live traffic status input from the client computing device 101 and/or database 130 for the program 200A, 200B to analyze. A user may select live traffic status inputs on the graphical user interface (GUI) on the client computing device 101. The available live traffic status inputs may be viewed in a list or displayed on a 2D digital map in the geographical area, such as a road, highway, etc., in which they are located. A user may be any person who is using the program 200A. Upon selection of a live traffic status input, the program 200A, 200B can gather the real-time traffic data from the collection of one or more IoT device(s) 250 in the selected live traffic status input.

At 304, the program 200A, 200B identifies the objects comprised within the real-time traffic data. The program 200A, 200B can identify objects, such as vehicles, within the real-time traffic data. The program 200A, 200B can use object image recognition technology, such as IBM Watson® Visual Recognition (IBM Watson® and all IBM Watson®-based trademarks and logos are trademarks or registered trademarks of International Business Machines Corporation, and/or its affiliates), to identify the objects comprised within the live-traffic data.

At 306, the program 200A, 200B determines traffic characteristics of the identified objects. The real-time traffic data may comprise context data in a predetermined data structure comprising attributes of identified objects, such as the identification of the road a vehicle is traveling on, the type, maker, model, color, location, speed, acceleration, and direction of vehicles, and time stamps. The program 200A, 200B can use fine-grained location-based services to collect the real-time traffic data comprising the relative positions of the identified vehicles, and to determine other traffic data such as how many lanes are on the road, a distance of objects from a certain vehicle, etc. The program 200A, 200B can use fine-grained location-based services, such as IBM Cloud Paks® (IBM Cloud Paks® and all IBM Cloud Paks®-based trademarks and logos are trademarks or registered trademarks of International Business Machines Corporation, and/or its affiliates). Additionally, the program 200A, 200B can classify the relative positions of the identified objects to one another, such as front-left, front, front-right, left, right, rear-leaf, and rear-right, based on the location(s) of the identified vehicles.

At 308, the program 200A, 200B converts the collected real-time traffic data to virtualized live traffic images. Virtualized live traffic images may comprise an aerial image, for example, a birds-eye view, of a vehicle, and other vehicles on a road. The real-time traffic data may comprise collected images relating to the side-view images, front-view images, back-view images, etc. of a vehicle. The program 200A, 200B can convert the collected image(s) to aerial image(s) using inverse perspective mapping.

At 310, the program 200A, 200B stitches the virtualized live traffic images together to create a virtualized live traffic stream. The program 200A, 200B can stitch together multiple virtualized live traffic images, creating a larger image comprising a wider aerial view of the geographical area comprising the live traffic status input(s). The program 200A, 200B can leverage image stitching methods, such as using scale-invariant feature transformation (SIFT) in combination with a homography matrix, to blend the virtualized live traffic images.

In some embodiments of the invention, the program 200A, 200B may stitch virtualized live traffic images together with generated map images from communication interfaces 250 within a vehicle that is not sharing movement characteristics such as position, speed, direction, etc. For example, a truck might not be sharing movement characteristics with the network 102. However, the program 200A, 200B may estimate the truck's location through data provided from communication interfaces 250, such as a radio, from the truck to nearby identified vehicles. The nearby identified vehicles may estimate their proximity to the truck through their communications with the communication interfaces 250 in the truck. The program 200A, 200B may estimate the location of the truck based on the truck's proximity to the nearby identified vehicles. The program 200A, 200B may create a generated map image based on the determined location of the vehicle and may stitch the generated map image together with the virtualized live traffic images.

At 312, the program 200A, 200B renders the virtualized live traffic stream on the client device 101. The virtualized traffic stream may be viewed on the GUI of the client computing device 101. The virtualized traffic stream may comprise a virtualized 2D map and/or live video.

At 314, the program 200A, 200B modifies the virtualized live traffic stream. The program 200A, 200B can modify the virtualized live traffic stream based on user preferences. User preferences may comprise objects that the user is interested in seeing in a virtualized live traffic stream, such as highlighting trucks on the road, only displaying vehicles that are not blue on the road, only displaying vehicles that are a certain color car on a highway, only displaying vehicles that are going at a certain speed on a highway, etc. The program 200A, 200B may check the user's profile to check if a user has any preferences listed. If the user has preferences listed in their profile, the program 200A, 200B can modify the virtualized live traffic stream by rendering highlighted and/or removing identified objects, etc., in the current frame of the virtualized live traffic stream on the client device 101. For example, the program 200A, 200B may highlight red trucks or remove identified vehicles going slower than a certain speed.

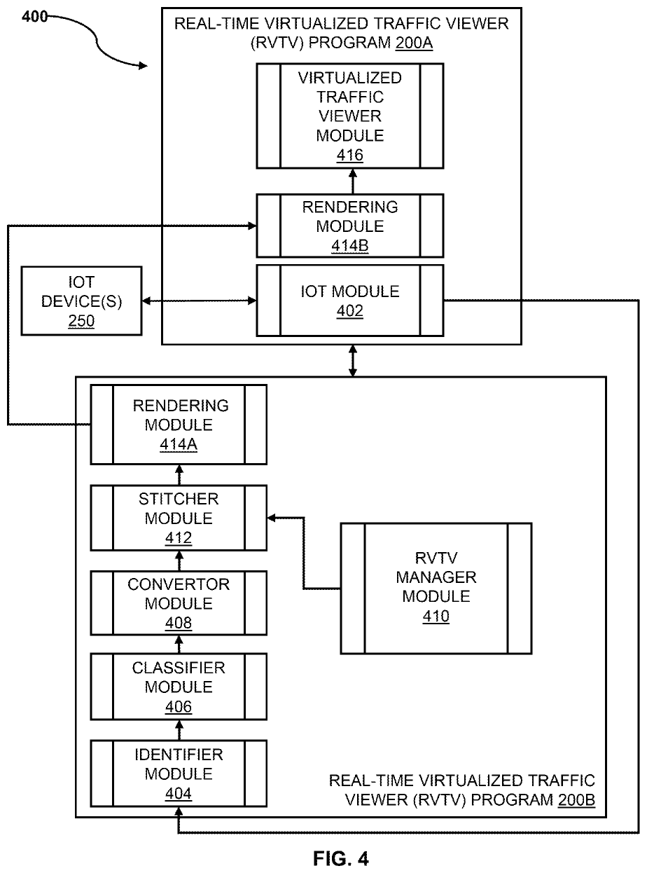

Referring now to FIG. 4, a system diagram illustrating an exemplary program environment 400 of an implementation of a real-time virtualized traffic viewer process 300 is depicted according to at least one embodiment. Here, the program 200A comprises an IoT module 402, a rending module 414B, and a virtualized traffic viewer module 416. The program 200B comprises identifier module 404, classifier module 406, convertor module 408, RVTV manager module 410, stitcher module 412, and rendering module 414A. The exemplary program environment 400 details the interactions between the real-time virtualized traffic viewer program 200A and the real-time virtualized traffic viewer program 200B, the real-time virtualized traffic viewer program 200A and the IoT device(s) 250, IoT module 402 and identifier module 404, and rendering module 414A and rendering module 414B. Additionally, the exemplary program environment 400 details the interactions between identifier module 404 and classifier module 406, classifier module 406 and the convertor module 408, convertor module 408 and stitcher module 412, RVTV manager module 410 and stitcher module 412, stitcher module 412 and rendering module 414A, and rendering module 414B and virtualized traffic viewer module 416.

The IoT module 402 may be used to communicate with and collect data from the IoT device(s) 250. The identifier module 404 may be used to identify objects, such as vehicles, in the real-time traffic data. The classifier module 406 may be used to determine the characteristics of the identified objects and classify them into different relative positions. The convertor module 408 may be used to convert the real-time traffic data into the virtualized live traffic images. The RVTV manager module 410 may comprise a service profile, data structure for saving and tracking real-time live data, criteria for augmenting objects, and copies of the user profiles. The stitcher module 412 may be used to stitch together the virtualized live traffic images. The rendering module 414A may be used to render the stitched virtualized live traffic stream. The rendering module 414B may be used to render the highlighted objects in the current frame of the virtualized live traffic stream. The virtualized traffic viewer module 416 may be used to display the virtualized traffic stream.

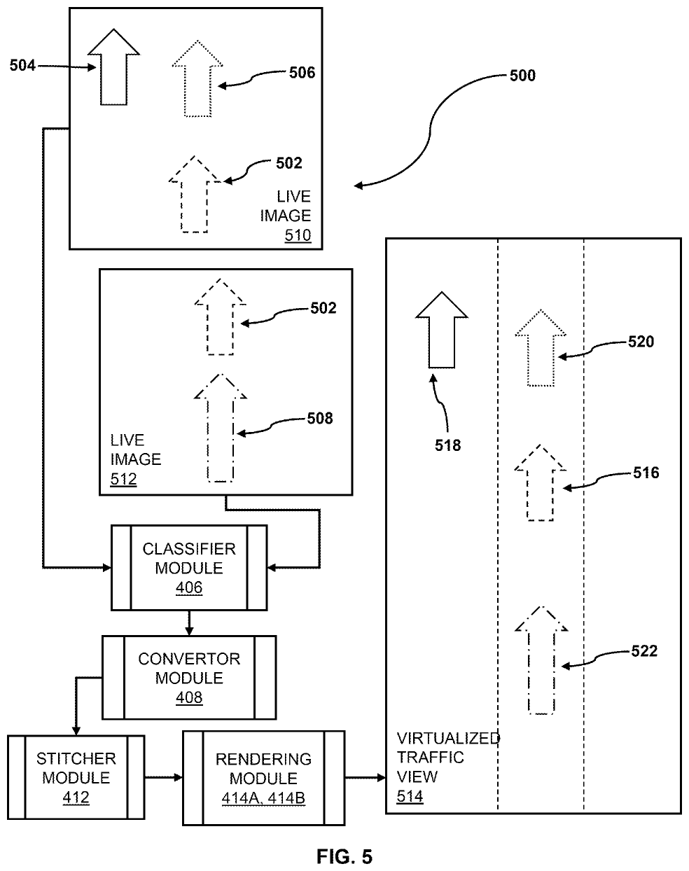

Referring now to FIG. 5, an operational flowchart illustrating an IoT data to live virtualized traffic map process 500 is depicted according to at least one embodiment. The IoT data to live virtualized traffic map process 500 displays live images 510, 512, classifier module 406, convertor module 408, stitcher module 412, rendering module 414A, 414B, and virtualized real-time traffic view 514. Live image 510 may comprise vehicle A 502, vehicle B 504, vehicle C 506. Live image 512 may comprise vehicle A 502 and vehicle D 508. Virtualized real-time traffic view 514 may comprise rendered vehicle A 516, rendered vehicle B 518, rendered vehicle C 520, and rendered vehicle D 522. Additionally, the IoT data to live virtualized traffic map process 500 displays communications between live image 510 and classifier module 406, live image 512 and classifier module 406, classifier module 406 and convertor module 408, convertor module 408 and stitcher module 412, stitcher module 412 and rendering module 414A, 414B, and rendering module 414A, 414B and virtualized real-time traffic view 514. While only four vehicles are shown, any number of vehicles may be included in the IoT data to live virtualized traffic map process 500.

It may be appreciated that FIGS. 2 through 5 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for generating a real-time virtualized traffic view, the method comprising:
receiving real-time traffic data from one or more selected live traffic status inputs;
identifying one or more objects comprised within the real-time traffic data;
determining one or more traffic characteristics of the identified objects;
converting classified real-time traffic data to one or more virtualized live traffic images;
stitching the one or more virtualized live traffic images together to create a virtualized live traffic stream; and
rendering the virtualized live traffic stream on a client device.

2. The method of claim 1, further comprising:
modifying the virtualized live traffic stream.

3. The method of claim 2, wherein the modifying of the virtualized live traffic stream comprises rendering one or more highlighted objects in the virtualized live traffic stream in a current frame on the client device based on user preferences.

4. The method of claim 1, further comprising:
classifying the real-time traffic data.

5. The method of claim 1, wherein the virtualized live traffic stream may comprise a live video or a two-dimensional digital map.

6. The method of claim 1, further comprising:
a network of one or more internet of things devices collecting the real-time traffic data.

7. The method of claim 1, wherein a live traffic status input comprises a network of one or more internet of things devices.

8. A computer system for generating a real-time virtualized traffic view, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving real-time traffic data from one or more selected live traffic status inputs;
identifying one or more objects comprised within the real-time traffic data;
determining one or more traffic characteristics of the identified objects;
converting classified real-time traffic data to one or more virtualized live traffic images;
stitching the one or more virtualized live traffic images together to create a virtualized live traffic stream; and
rendering the virtualized live traffic stream on a client device.

9. The computer system of claim 8, further comprising:
modifying the virtualized live traffic stream.

10. The computer system of claim 9, wherein the modifying of the virtualized live traffic stream comprises rendering one or more highlighted objects in the virtualized live traffic stream in a current frame on the client device based on user preferences.

11. The computer system of claim 8, further comprising:
classifying the real-time traffic data.

12. The computer system of claim 8, wherein the virtualized live traffic stream may comprise a live video or a two-dimensional digital map.

13. The computer system of claim 8, further comprising:
a network of one or more internet of things devices collecting the real-time traffic data.

14. The computer system of claim 8, wherein a live traffic status input comprises a network of one or more internet of things devices.

15. A computer program product for generating a real-time virtualized traffic view, the computer program product comprising:
one or more computer-readable tangible storage medium and program instructions stored on at least one of the one or more tangible storage medium, the program instructions executable by a processor to cause the processor to perform a method comprising:
receiving real-time traffic data from one or more selected live traffic status inputs;
identifying one or more objects comprised within the real-time traffic data;
determining one or more traffic characteristics of the identified objects;
converting classified real-time traffic data to one or more virtualized live traffic images;
stitching the one or more virtualized live traffic images together to create a virtualized live traffic stream; and
rendering the virtualized live traffic stream on a client device.

16. The computer program product of claim 15, further comprising:
modifying the virtualized live traffic stream.

17. The computer program product of claim 16, wherein the modifying of the virtualized live traffic stream comprises rendering one or more highlighted objects in the virtualized live traffic stream in a current frame on the client device based on user preferences.

18. The computer program product of claim 15, further comprising:
classifying the real-time traffic data.

19. The computer program product of claim 15, wherein the virtualized live traffic stream may comprise a live video or a two-dimensional digital map.

20. The computer program product of claim 15, further comprising:
a network of one or more internet of things devices collecting the real-time traffic data.
